(19) United States
(12) Patent Application Publication
(10) Pub. No.: US 2017/0226693 A1
(43) Pub. Date: Aug. 10, 2017

(54) PROCESSOR, DEVICE COMPRISING A PROCESSOR, CYCLONE AND METHOD FOR TREATING A MATERIAL MIXTURE

(71) Applicant: Repa Boltersdorf GmbH, Brohl-Luetzing (DE)

(72) Inventor: Hans-Joachim BOLTERSDORF, Brohl-Luetzing (DE)

(73) Assignee: Repa Boltersdorf GmbH, Brohl-Luetzing (DE)

(21) Appl. No.: 15/503,110

(22) PCT Filed: Aug. 14, 2015
(86) PCT No.: PCT/DE2015/000405

§ 371 Date: Feb. 10, 2017

(30) Foreign Application Priority Data
Aug. 14, 2014 (DE) 10 2014 011 942.4
Mar. 4, 2015 (DE) 10 2015 002 683.6

(51) Int. Cl. D21B 1/34; D21B 1/06; D21B 1/32

(52) U.S. Cl. CPC D21B 1/34; D21B 1/32; D21B 1/063; B02C 23/08

(57) ABSTRACT

A method for treating composite materials of aluminum and plastics mixes the composite materials in a working area of a processor under high shear forces with a spiral in order to remove the aluminum layer from the plastic layer and to suspend it. The particles which are separated by a screen from the working area are treated in a hydrocyclone in order to separate aluminum from the liquid, wherein fibers present in the underflow are fed back with the liquid to the processor.

The invention relates to a processor, to an apparatus having a processor, to a cyclone, and to a method for treatment of a substance mixture.

The invention particularly relates to a method for treatment of a substance mixture composed of different materials, in which the substance mixture is mixed under high shear forces in a work region of a processor. The processor is generally a pulper having a screw or a spiral. If the processor is also used for removing fine grains such as fibers, for example, then it has a screen or a perforated metal sheet that separates a surface flow from an underflow. The invention therefore also relates to an apparatus for carrying out a method using a processor having a screw and a surface flow, which is separated from an underflow by a screen.

A pulper can be used, for example, for separating aluminum from multi-layer packaging by means of high shear forces. Such packaging is also referred to as composite packaging, and has different materials such as plastics, aluminum, cardboard, and paper. The production of such composite packaging generally takes place by way of coating, lamination or metallization. Known packaging is, for example, blister packs in which tablets are primarily packaged. However, a substance mixture composed of different materials can also occur during shredding of electrical circuits.

The best-known use in the sector of such composite packaging is the foods sector, in which juice cartons and milk cartons or frozen food boxes and bags for instant soups are known, for example. Separation of the different materials of composite packaging after use, within the scope of waste handling, can be performed only with great effort. The paper or cardboard component can be removed most easily. For this purpose, the composite material is soaked. When this happens, the paper fibers absorb water, swell up, and separate from the thin layers of polyolefins and aluminum. Polyethylene is frequently used as a polyolefin. The pulp is then cleaned after separation, thickened, and processed further to produce paper or paperboard. The paper components or cellulose fibers make up about 75% of the total volume in usual composite packaging. Olefins and aluminum can also be separated from the cellulose by means of the use of special chemicals.

However, after removal of the fiber materials, separating the remainder of olefins and the aluminum layer or multiple olefin layers and aluminum layers is problematical. Therefore these layers either end up in the cement industry, without being separated, where the plastic component serves as an energy supplier and the aluminum has an effect on the strength of the concrete produced from the cement, or the aluminum is recovered in pure form in systems in which the plastics are converted to gas. Attempts were also made to separate the aluminum from polyethylene using hot organic solvents.

Washing methods using large amounts of different chemicals make it possible to separate aluminum and olefins from the composite. However, the high consumption of chemicals and the separation of aluminum and olefins are problematical in this regard.

Aside from composite materials, further material mixtures exist, which must be separated with as much varietal purity as possible. It is true that conventional processors allow separation, but with great effort. In the case of many material mixtures, however, it is very difficult to achieve acceptable varietal purity. In particular, composite materials and, in particular, composite materials that have aluminum and olefins, are supposed to be separated more easily.

When mixing the substance mixture, foams that hinder processing occur, above all when using a washing liquid.

The invention is therefore based on the task of further developing a process of the stated type, and making available an apparatus, a cyclone, and a method, with which substance mixtures composed of different materials can be separated.

This task is accomplished with a processor according to claim 1, an apparatus according to claim 9, a cyclone according to claim 16, and a method according to claim 24. Advantageous further developments are the object of the dependent claims.

The processor is suitable for all types of composite materials, independent of the type of combined materials. Such composite materials can have plastics or metals or paper, for example.

Such a cyclone has a head region that has a decentralized, preferably tangential inflow and a central outflow, and in which a widening exit cone follows the central outflow. This is therefore a double cyclone, which at first narrows or remains cylindrical in the flow direction, and then widens to bring about optimal separation.

The discharge cone can be followed by a collection cone that narrows again. Fractions of the substance mixture, which are supposed to be discharged at the hydrocyclone, collect in this collection cone. For this purpose, the discharge cone or the collection cone is preferably followed by a closable discharge opening. In a preferred exemplary embodiment, this discharge opening is configured as a sluice.

Feed openings in the lower region of the cyclone, such as in a discharge cone or a collection cone, for example, allow inflow of a liquid or a gas. In this way, the materials situated in the cyclone can be swirled up, so that they can be conducted to the separation region of the cyclone once again.

In order to prevent entanglement of material on the central outflow, it is proposed that the cyclone has a ceiling in which a central outflow is disposed in such a manner that it does not project into the cyclone. The central outflow of the cyclone then does not have an immersion pipe, so that the outflow can be configured in the ceiling of the cyclone without projecting elements.

In this regard, it has proven to be advantageous if the ceiling of the cyclone, on which the outflow is provided, is configured to have a convex curvature or to narrow conically toward the outflow. In the case of a vertical cyclone, the central outflow is then disposed at the highest point of the cyclone. In this way, particles are prevented from collecting around the outflow in the region of the ceiling of the cyclone.

It has been shown that such a cyclone is particularly suitable for a method that treats substance mixtures in order to separate fractions from the mixture.

The cyclone, as a hydrocyclone or also as a cyclone operated with gas, such as air, in particular, has proven to be particularly advantageous, above all, for separation of substance mixtures that have a composite material, such as with aluminum and plastic, in particular.

The cyclone can be connected with the underflow of the processor, in order to remove sand types or aluminum particles, for example, which were separated from the material in the processor. A small cyclone, which does not have to be operated in circulation, is sufficient for this purpose.

Alternatively or cumulatively, a further, much larger cyclone can be provided, which is connected with the surface flow of the processor. For this purpose, materials are removed from the surface flow, preferably using a screw, which materials are treated in the cyclone and subsequently returned to the processor again above the screen.

Particularly for such a large cyclone, it is proposed that the input of a pump is connected with the surface flow discharge of the processor, and an output of the pump is connected with the decentralized inflow of the cyclone, wherein the central outflow of the cyclone is connected with the surface flow entry of the processor.

It is advantageous, for example, if the pump is a centrifugal pump. A centrifugal pump can convey a large volume, on the one hand, and on the other hand can also break up materials and shred pieces of wood, for example. It thereby acts like a hammer mill.

In order to maintain the spiral movement in the cyclone or to influence it, it is proposed that the apparatus has a circulation pump that promotes transport from the central outflow of the cyclone to the decentralized inflow of the cyclone.

It is advantageous if the apparatus has a filter, the liquid inflow of which is connected with the underflow of the processor, and the liquid outlet of which is connected with the inflow of the centrifugal pump. Thereby, fiber materials can be discharged at the filter, which can also be configured as a disk filter, while the liquid is returned to the circulation of the centrifugal pump.

In order to pre-clean the discharge from the processor, it is proposed that the apparatus has a further cyclone, which is disposed between the underflow of the processor and the filter.

Furthermore, the apparatus can have a buffer that is provided between the surface flow of the processor and the centrifugal pump.

The method for treatment of a substance mixture can be carried out continuously. However, it is particularly advantageous if separation of the fractions from the mixture is carried out in batch operation. In this regard, the mixture is passed through the hydrocyclone multiple times, and the various fractions that separate from the mixture are gradually taken out of the circulation. Thereby a predetermined amount is treated and circulated until those fractions that are supposed to be removed, according to a specification, have been removed. Afterward, a further amount is treated as the next batch. In this regard, the batches can be taken out of a buffer according to the First In First Out principle.

In this regard, it is advantageous if a circulation between the central outflow of the cyclone and a decentralized inflow maintains, increases or lowers the rotation in the cyclone, while a second circulation between the central outflow of the cyclone and the decentralized inflow of the cyclone is passed by way of a processor, in order to separate the materials by means of the shear forces that occur in the processor. For this purpose, the processor is preferably operated at a high substance density.

In carrying out the method, it is advantageous if the aluminum layer is broken up, detached, and suspended as particles in the processor, by means of high shear forces and using chemicals.

The particles, which are washed out in the underflow of the processor, can be treated further in a hydrocyclone, preferably a single-stage hydrocyclone, in order to remove sand-like particles, in particular. Such a hydrocyclone has a simple structure, leads to a good degree of efficiency, and requires little energy. Depending on the use of chemicals, aluminum particles can also be conducted away in such a hydrocyclone. The fibers that occur in the cyclone can be removed either in a disk filter or a thickener, or can be returned to the processor again in the region of the surface flow.

After completion of such a separation process, multi-stage washing can follow, which begins with highly enriched washing water and ends with quasi fresh water.

The chemical losses are minimal in this process, because the concentration differences are slight (quasi continuous-flow method), and therefore also the demand for washing water is low.

At the end, the washed plastics can be removed from the system by means of a spiral scraper, and the process can be started again, in other words the processor is charged with new material and recycled chemicals.

During mixing of the substance mixture in the working region, part of the mixture can be removed from the working region of the processor using a screw conveyor. In a special version of the method, mixture is conveyed out of the screw conveyor back into the working region after a specific processing time, by means of reversing the screw conveying direction of the spiral scraper.

This leads to the result that a batch is treated in the working region, during the batch process, until hardly any finer material is discharged through the screen any more, and also, hardly any coarse material is situated in the working region any longer. Then, the remaining material coming from the cyclone can be enriched with the material already situated in the screw conveyor or spiral conveyor, in order to improve the grinding process in the processor.

In order to be able to separate the mixture more easily in the processor and/or in the cyclone, it is proposed that separation of the fractions from the mixture is carried out in a liquid that is lighter or heavier than water. This can be achieved, for example, by means of adding salt or alcohol to the water. However, hydrophobic liquids such as oils, for example, can also be used.

Materials having a density greater than 1 are generally precipitated in the hydrocyclone. However, this can be influenced by means of special flow conditions. For this purpose, a liquid such as water, in particular, can be supplied at the lower end of the hydrocyclone, in a narrowing collection cone or a discharge cone, in order to achieve a counter-flow. Preferably, the liquid is supplied by way of nozzles or inflow openings. These can be disposed in one or more planes, distributed over the circumference. The inflow should be dimensioned in such a manner that a laminar flow promotes separation.

In the following, the invention will be explained in greater detail using exemplary embodiments. The drawing shows:

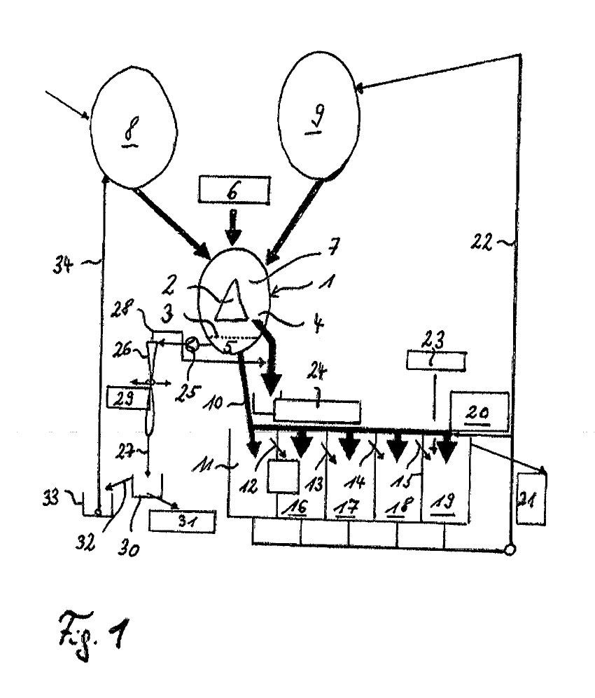

FIG. 1 schematically, an apparatus for treatment of composite materials, using a small hydrocyclone,

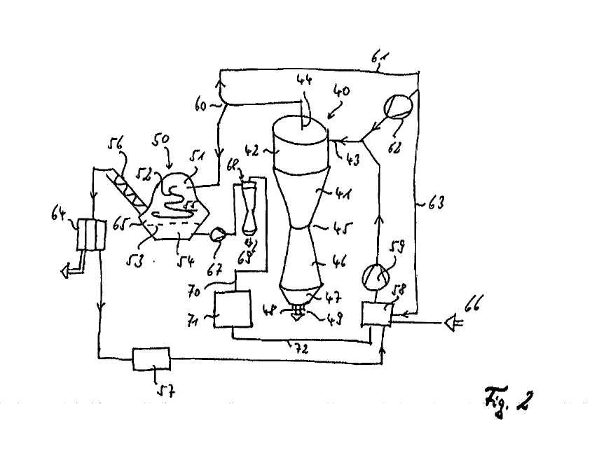

FIG. 2 schematically, an apparatus for treatment of composite materials, using a small and a large hydrocyclone,

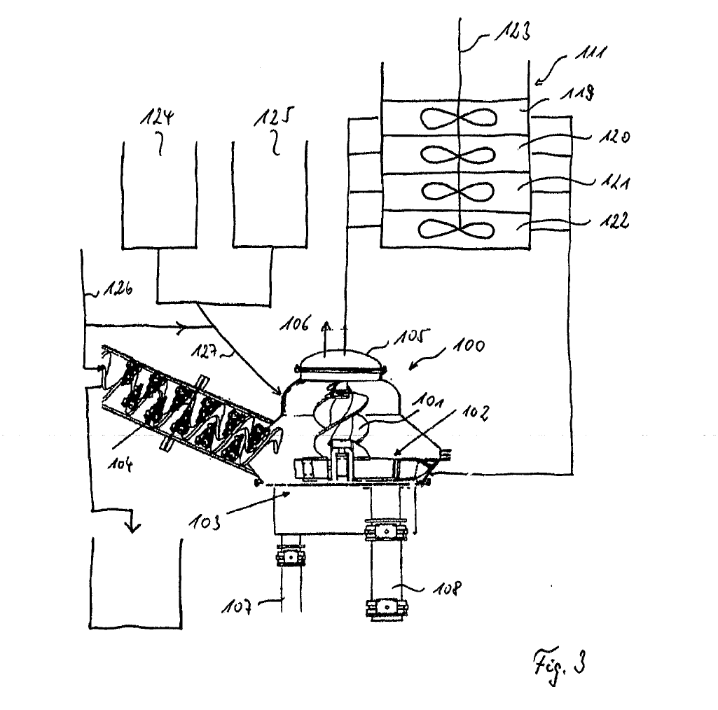

FIG. 3 schematically, an apparatus with a washer,

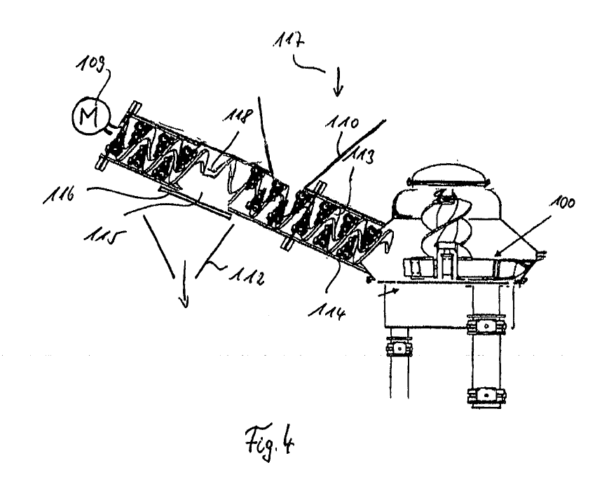

FIG. 4 an processor having an intake screw and a discharge screw, and

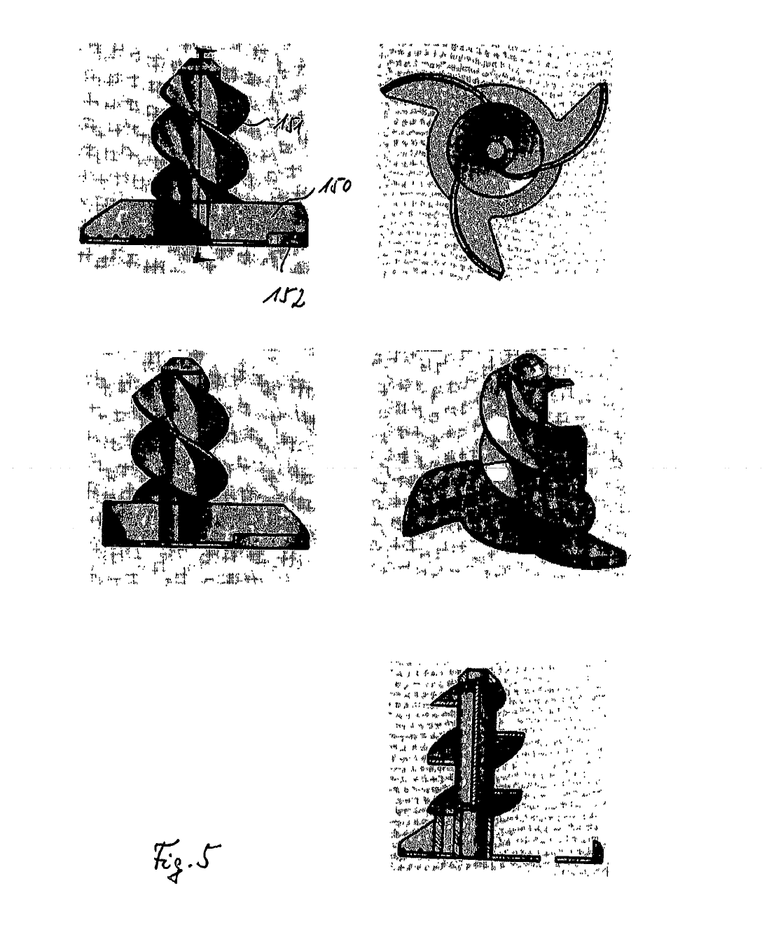

FIG. 5 multiple views of a screw with a scraper.

FIG. 1 shows the processor 1 with the schematically represented screw 2 and a screen or perforated metal sheet 3, which separates a region for the surface flow 4 from a region for the underflow 5.

The processor 1 is connected with a material feed for composite materials 6. Furthermore, a micro-emulsion 8 and a washing emulsion 9 are added in a working region 7 in which the screw 2 is disposed. In the processor 1, micro-emulsion 8, composite materials 6, and washing emulsion 9 are strongly mixed with one another using the screw 2, and the friction of the substances against one another leads to the result that finer particles flow away by way of the underflow 5, while coarser particles such as plastics are removed from the processor by way of the surface flow.

In order to have high shear forces in the processor, which bring about strong friction of the materials against one another, a substance density of more than 10 GG, preferably above 20% GG, and, in practice, depending on the material, particularly preferably, of about 30% GG. This means that per 10 kg of dry substance mixture, at most 90 kg water are used. The power consumption at the spiral that turns in the processor or of scrapers moved in the processor increases due to the reduction in water content—however, the shear forces that bring about friction of the particles against one another increase.

In order to drive air out of the mixture, first stirring takes place at a low speed of the rotor at its radially outermost end, at about 1 m/s. In this process, air or gas is drawn off at the upper end of the processor, at a ventilation opening. Subsequently, the processor continues to be filled with mixture until the mixture is pressed into the processor. As a result, the power consumption at the rotor increases. On the other hand, however, the shear forces also increase. It has been shown that a speed of the rotor at its radially outermost end of below 5 m/s and a substance density of 20 to 30% GG leads to optimal results with regard to material separation and power consumption.

The liquid 10 of the underflow 5 is passed to a first bath 11. Subsequently, the liquid from the bath 16 is passed to the processor and, after being mixed with the residual chemicals still remaining in the plastics is passed back into the same bath 16—the same method of procedure is used for the baths 17 to 19.

The addition of dilution water 20 from the containers 16 to 19 into the baths 11 and 16, 17, 18, 19 leads to the result that the bath 11 still contains a very highly concentrated washing emulsion, while the baths 16, 17, 18, 19 have washing emulsions that are constantly diluted further, so that ultimately, a highly diluted washing emulsion is passed out of the bath 19 to a sewage treatment plant 21 by way of the overflow.

For final dilution, fresh water 23 is supplied to the container 19. The plastics 24 removed by way of the surface flow are completely de-watered (pressed off) and are available for further processing.

The material of the underflow 5 is conveyed into a hydrocyclone 26 by way of a pump 25, where the aluminum is separated from the liquid 28—the fiber materials are entrained by means of flow separation, by way of the overflow 28, and returned to the system. A sensor 29 serves for determining the precise point in time of initiation of the washing process. The mixture of aluminum and fibers is separated in the container 30, in that the setting aluminum 31 is used further, while the liquid 32 is added to a container 33 as overflow: From there, the liquid 34 gets to the micro-emulsion 8, with which it is returned to the processor 11 again.

FIG. 2 shows the inclusion of the processor shown in FIG. 1 or a similar processor in an apparatus having a large hydrocyclone 40. This hydrocyclone 40 has an input cone 41 and a head region 42. A tangential inflow 43 and a central outflow 44 are provided. The input cone 41 can extend all the way to the head region 42, so that the head region is also configured conically. In an alternative embodiment, the input cone 41 can also be configured cylindrically.

At the lower end of the input cone 41, there is a smaller diameter 45 that makes a transition, like a constriction, from the input cone 41 into a widening output cone 46. A collection cone 47 that narrows again is provided at the lower end of the output cone 46, and has a discharge opening 49 closed off by means of a sluice 48.

A processor 50 has a screw 52 in its upper region 51, and below that a screen 53 that separates the upper region 51 from an underflow 54.

The substance mixture 55 treated in the processor 50 is discharged using a discharge screw 56 and conveyed to a buffer 57, which can accommodate a larger amount of the substance mixture, in order to supply it to a collector 58 as needed, from where the material is conveyed to the decentralized inflow 43 of the hydrocyclone 40 by way of a centrifugal pump 59. The collector 58 serves for diluting the material conducted in circulation with water, and then to apply it to the centrifugal pump 59 in liquefied form. The collector 58 can therefore be configured as a screw conveyor, to which fluid is applied, in order to achieve a consistency that can be conveyed by way of the centrifugal pump 59.

In place of discharge spiral or discharge screw 56 and buffer 57, a particularly large discharge spiral (see FIG. 3) can also be provided, which makes it possible, on the one hand, to draw material off from the surface flow of the processor, and, on the other hand, to store as much material as possible, which is then gradually liquefied and applied to the centrifugal pump.

In the hydrocyclone, the material at first migrates in spiral shape up to the construction 45, and from there, further into the output cone 46, where a material fraction is removed by way of the sluice 48. The remaining material migrates in spiral shape in the output cone 46, back upward into the input cone 41, and, by way of the central outflow 44, back to the processor 50.

Feed openings 73 in the lower region of the cyclone make it possible to supply water or a different liquid, in order to facilitate separation of the material in the cyclone by means of a flow component that is directed radially from the outside to the inside. For this purpose, the feed openings can be configured as nozzles that allow a liquid to enter into the cyclone in a defined flow direction.

The main flow gets into the line 61 at the switch 60, in an arc, and from there to the circulation pump 62. This circulation pump 62 thereby provides conveying from the central outflow 44 of the cyclone 40 to the tangential inflow 43 of the cyclone 40.

A bypass 63, which is not absolutely necessary, makes it possible to draw a partial stream off ahead of the circulation pump 62, and to tie it up to the centrifugal pump 59, directly or by way of the collector 58.

The circulation between hydrocyclone 40, processor 50, and centrifugal pump 59 makes it possible to treat the mixture 55 over a longer period of time and, in this process, to remove different fractions from the circulation at the discharge opening 49.

When all the fractions that contain value have been removed, the slide switch 64 is changed over and the light material, such as, in particular, polyolefins such as polyethylene and polypropylene, is discharged.

In this process, different plastic materials can already be removed by means of the selection of the liquid 65 and the hydrocyclone 40. Alternatively, the plastics can also be removed after the switch 64, in a further cyclone that contains a liquid that is lighter or heavier than water.

New material is supplied to the collector 58 as a substance mixture 66, either ahead of the centrifugal pump 59 or at different location, such as, for example, at the buffer 57.

The underflow 54 of the processor 50 is conducted to a small cyclone 68 by way of a pump 67, where sand types or, for example, also aluminum 69 is/are removed and discharged, while the substances, such as, in particular, fiber materials 70 are passed to a filter 71. Here, the fiber materials are removed, while the liquid gets to the collector 58 by way of the line 72, and from there to the centrifugal pump 59.

FIG. 3 shows a processor 100 having a spiral 101 and a scraper 102. A sheet-metal screen or perforated metal sheet 103 is disposed under the scraper 102. On the side, a screw 104 is disposed on the processor 100, and a ventilation 106 is provided on the ceiling 105 of the processor 100, which allows air to escape, particularly during the filling process. A suction system (not shown) can be connected to this ventilation opening 106, in order to generate a partial vacuum in the processor 100. Such a ventilation opening prevents excess pressure in the processor. Depending on the material to be treated and the washing liquid used, it is also possible to do without a ventilation opening. The fiber material discharge 107 is under the perforated metal sheet 103, and next to that there is a residual substance discharge 108.

A screw 104, which is suitable for input into the processor 100 and for discharge from the processor 100, is shown in FIG. 4. There, material can be supplied by way of the funnel 110, and material that falls out of the screw can be captured by way of the funnel 112.

The spiral 113 of the screw 104 is disposed in a pipe 114 that has an opening 115. In the axial direction ahead of and after the opening 115, the spiral 113 has an opposite pitch. The regions of the spiral with an opposite pitch are connected with a pipe scraper 118 that slides along the inside of the pipe 114 to prevent adhesions. A slide 116 makes it possible to close off the opening.

It is advantageous if—as shown in the figure—two openings spaced apart from one another are provided. In this regard, it is practical if one opening for filling the processor is disposed closer to the processor than the further opening for emptying the processor. In this way, it is possible to fill and empty the processor in simple manner, using a single screw or spiral.

The spiral 113 is axially displaceable in the pipe 114, in order to push it as close as possible to the scraper 150 without having to move the entire screw.

The processor 100 shown in FIG. 3 is connected with a container 111, which has multiple chambers 119 to 122 one on top of the other. A stirrer mechanism 123 has multiple stirrer blades with which the fluid can be stirred in each of the chambers.

Container 124 and 125 make it possible to supply washing liquid and washing water to the processor.

Material to be treated can be supplied by way of a line 126. The line 127 makes it possible to supply this material tangentially to the upper region of the processor.

Particular dynamics and keeping the wholes of a perforated metal sheet clear are achieved with the scraper 150 shown in FIG. 5. It is welded onto the underside of a screw 151 and has a wall that runs essentially perpendicular to a horizontal screen surface, in order to push the material over the screen surface. A slide that can be precisely positioned is disposed on the underside of the scraper, which slide makes it possible to guide the slide at a distance of only 1 mm over a perforated metal sheet. In this way, holes in the perforated metal sheet can be brushed clear with the material to be treated.

The simplest variant for operation of such a processor 100 or of the processors 1 and 50 is batch operation with dry material feed.

In a method of operation as true batch operation (filling/emptying), which is advantageous, for example, for processing of composites without a fine-grain component (for example fiber materials), only the processor is required.

The required liquid medium is supplied to the reactor by means of a pump, while the rotor is standing.

The filling process is completed when no more air rises up. At the end of the filling process, the rotor is rotated slowly, for example at a circumferential speed of approximately 1 m/s.

The material is supplied by way of the screw 104, which serves as a discharge system that runs backwards, up to the performance limit of the drive 109—specifically by means of the set-on funnel 110. In this regard, the material is stuffed into the processor, in order to treat as much compressed material there as possible. Toward the end of the performance curve (but still clearly before that), the speed of rotation of the processor is slowly raised to pulping speed (approximately 4 m/s). The pulping process subsequently takes place.

Then, at the end, the washing process is initiated—specifically preferably by means of what is called difference washing. In this regard, the pulping medium from the previous batch, in each instance, is removed from a container having a multi-chamber system (vertically one on top of the other, each having a stirring mechanism)—with a slightly lower content of the active component, in each instance. If this medium is now continuously supplied to the reactor, the concentration in the reactor constantly decreases with this type of washing—without the reactor having to be drained for this purpose. At the end, the liquid, which has only a very low concentration now, is drained, and flushing with fresh water takes place once. If necessary, a pressing-out process can be inserted in between. Flushing with fresh water reduces adhesions. At the end, material discharge takes place by means of the discharge system.

A method of operation as batch operation with a continuous underflow, for example, is suitable for reducing the content of fiber material and recovering the fiber material.

In the case of a method of operation with dry material feed, once again only the reactor is required as a component. The water feed takes place all the way at the top—tangentially, to utilize the inflow pulse as a turbine effect.

To fill the reactor, the material is applied by way of the funnel 110 of the discharge system—with simultaneous fiber pulping and also simultaneous fiber material washing. This process step takes place until about half of the proportional fiber material has been removed—measured by way of substance density and water flow in the underflow.

Subsequently, washed-out accompanying material is applied and the spiral is allowed to continue running until only such a small amount of fiber material is situated in the reactor that further washing would be inefficient. Inefficient with regard to the fiber material recovery, on the one hand, and with regard to the washing for plastic recovery, on the other hand.

At the end, the reactor is emptied by means of the discharge system—specifically emptied completely.

A further variant provides for feed of a suspension, in other words liquid feed. This process is similar to the method of operation described above. The material feed takes place, however, by means of a pump by way of the tangential input—for example by means of a centrifugal pump.

This process has the advantage, among other things, that mixing of substance and water already takes place beforehand—this significantly accelerates the washing process. Also, this results in the possibility of precipitating disruptive heavy parts beforehand—for example by means of a cyclone. Also, the suspender is able to pre-break large parts and thereby replaces an advance shredder, if applicable. Furthermore, because of the interplay of screw conveyor and suction-producing centrifugal pump, such a system is very much more powerful than the discharge spiral, which, in practice, must press against a high structural pressure for several minutes.

The material feed in turn takes place until about half of the proportional fiber material has been removed—measured by way of substance density and water flow in the underflow.

In contrast to a dry material feed, reducing the concentration of the remaining fiber material takes place in that the fill accompanying substance spiral is allowed to run backwards.

Subsequent emptying takes place until the power demand of the spiral drops. This guarantees that the discharge buffer is still (almost) full—full of washed accompanying substances. Then the next batch can start.

The batch operation shown in FIG. 2, with an external buffer, represents by far the most powerful variant, but also the most complicated one. Here, an external buffer is required. With this buffer, it is guaranteed that at every point in time of a batch, the maximally possible feed of fiber material takes place—and thereby also the greatest fiber material flow takes place.

For comparison: During batch, material with a full fiber material content is pressed into material without any fiber material content, approximately during the middle of the fiber material recovery time (before the change in material feed), and afterward, material without any fiber material is mixed with material that still has a significant fiber material content. Entropy occurs to a significant degree both times.

With regard to the process as such: The completely empty system is filled by means of suspension, subsequently operated in circulation until the desired residual fiber material content is foreseeable. Then emptying into the reject buffer takes place by means of a switch, and from there the material is placed into the reject press.

1. Processor having a container, in which a screw (2, 52) is disposed, and a spiral that leads into the container, wherein the container is closed in pressure-tight manner and has a ventilation opening (106) at its top.

2. Processor according to claim 1, wherein it has a suction device that is connected with the ventilation opening (106).

3. Processor according to claim 1, wherein it has a perforated metal sheet or screen (3, 53) and at least one scraper (150), which is welded onto the underside of the screw (151) and has a slide (152), which is disposed, at a distance of less than 3 mm, preferably less than 2 mm, from the perforated metal sheet or screen.

4. Processor according to claim 3, wherein the slide (152) is releasably disposed on the scraper (150).

5. Processor according to claim 1, wherein the spiral (113) is axially displaceable, so that it can be brought up close to the scraper (150).

6. Processor according to claim 1, wherein the spiral (113) is disposed in a pipe (114), which has an opening (115), wherein the spiral (113) is disposed ahead of and after the opening (115) in the axial direction, and has an opposite pitch ahead of the opening (115) as compared with after the opening (115).

7. Processor according to claim 6, wherein the spiral (113) does not have a core and has a pipe scraper (118) between the regions with opposite pitch, which scraper connects these spiral regions.

8. Processor according to claim 1, wherein the upper region of the container has a circular cross-section and a suspension feed leads tangentially into the upper region.

9. Apparatus having a processor (1, 50), according to claim 1, having a surface flow (56) that is separated from an underflow (5, 54) by means of a screen or perforated metal sheet, wherein it has a cyclone, the decentralized inflow (43) of which is connected with the surface flow (56) or the underflow (5, 54) of the processor (1, 50).

10. Apparatus according to claim 9, wherein it has a pump (59, 62), the input of which is connected with the surface flow discharge (56) of the processor (50) and the output of which is connected with the decentralized inflow (43) of the cyclone (40), and wherein the central outflow (44) of the cyclone (40) is connected with the inflow (51) of the processor (50).

11. Apparatus according to claim 10, wherein the pump is a centrifugal pump (59).

12. Apparatus according to one claim 9, wherein it has a circulation pump (62) that conveys from the central outflow (44) of the cyclone (40) to the decentralized inflow (43) of the cyclone (40).

13. Apparatus according to claim 11, wherein it has a filter (71), the liquid inflow of which is connected with the underflow (5, 54) of the processor (1, 50), and the liquid outlet of which is connected with the centrifugal pump (59).

14. Apparatus according to claim 13, wherein it has a further cyclone (68) that is disposed between the underflow (54) of the processor (50) and the filter (71).

15. Apparatus according to claim 9, wherein it has a buffer (57) that is disposed between the surface flow (51) of the processor (50) and the centrifugal pump (59).

16. Cyclone (26, 68, 40), for a processor according to claim 1, having a head region, which has a decentralized, preferably tangential inflow (43), and a central outflow (44), wherein a widening output cone (46) follows the central outflow (44).

17. Cyclone according to claim 16, wherein the head region is cylindrical.

18. Cyclone according to claim 16, wherein a collection cone (47) that narrows again follows the output cone (46).

19. Cyclone according to claim 16, wherein a closable discharge opening (49) follows the output cone (46) or the collection cone (47).

20. Cyclone according to claim 19, wherein the discharge opening (49) has a sluice (48).

21. Cyclone according to claim 16, wherein feed openings (73) in the lower region of the cyclone, such as, for example, in a discharge cone (46) or a collection cone (47), allows inflow of a liquid or of a gas.

22. Cyclone according to claim 16, wherein it has a ceiling (74) in which a central outflow (44) is disposed in such a manner that it does not project into the cyclone.

23. Cyclone according to claim 16, wherein it has a ceiling (74) that is bent in convex shape or narrows conically toward the outflow (44).

24. Method for treatment of a substance mixture (6, 66) composed of different materials, using a processor according to claim 1, in which a washing liquid is added to the substance mixture, and the substance mixture (6, 66) is mixed in a working region of the processor (1, 50), by means of a rotor, under high shear forces, in order to separate at least one fraction from the mixture, wherein gas is drawn off from the processor.

25. Method according to claim 24, wherein the washing liquid has a surfactant.

26. Method according to claim 24, wherein separation of the fractions from the mixture (6, 66) is carried out in a liquid that is lighter or heavier than water.

27. Method according to claim 24, wherein the entire processor is filled with substance mixture and the substance density in the processor is above 10% GG, preferably above 20% GG or about 30% GG.

28. Method according claim 24, wherein during mixing, the speed of the rotor at its radially outermost end amounts to below 5 m/s.

29. Method according to claim 24, using a cyclone in which the substance mixture (6, 66) is mixed in a working region of the processor (1, 50) at high shear forces, in order to separate at least one fraction from the mixture, wherein this fraction is subsequently treated further in the cyclone.

30. Method according to claim 24, wherein the substance mixture (6, 66) has a composite material with a metal, such as aluminum, for example, and plastic.

31. Method according to claim 24, wherein the substance mixture is supplied to the processor and removed from it using the same spiral conveyor.

32. Method according to claim 24, wherein separation of the fractions from the mixture (6, 66) is carried out using a batch process.

33. Method according to claim 32, wherein after separation of a fraction of the substance mixture in the working region, a part of the mixture is removed from the working region of the processor using a spiral conveyor, and after a specific processing time, mixture is conveyed back into the working region from the spiral conveyor, by means of reversal of the screw conveying direction.

34. Method according to claim 24, wherein the washing liquid is kept on hand in containers with different washing liquid concentrations, and wherein liquid with a decreasing concentration is gradually supplied to the processor from the containers.

35. Method according to claim 24, wherein a mixture fraction is first treated in a first cyclone and afterwards treated in a second cyclone, wherein more fluid is supplied in a counter-stream in the first cyclone, to increase the separation precision, than in the second cyclone.
